(19) United States
(12) Patent Application Publication
(10) Pub. No.: US 2021/0133645 A1
(43) Pub. Date: May 6, 2021

(54) AUTOMATED GENERATION OF DOCUMENTS AND LABELS FOR USE WITH MACHINE LEARNING SYSTEMS

(71) Applicant: Element AI Inc., Montreal (CA)

(72) Inventors: Saad TAZI, Montreal (CA); Patrick LAZARUS, Montreal (CA); Jerome PASQUERO, Montreal (CA)

(73) Assignee: Element AI Inc., Montreal, QC (CA)

(21) Appl. No.: 17/259,687

(22) PCT Filed: Jul. 12, 2019
(86) PCT No.: PCT/CA2019/050961

§ 371 Date: Jan. 12, 2021

Related U.S. Application Data
(60) Provisional application No. 62/696,969, filed on Jul. 12, 2018.

(51) Int. Cl. G06Q 10/06; G06F 40/174; G06F 40/186; G06F 16/2458

(52) U.S. Cl. CPC G06Q 10/067; G06F 40/174; G06Q 30/04; G06F 16/2471; G06F 40/186

(57) ABSTRACT

Systems and methods for automated generation of documents. In one system, different databases, each having a different type of data, are used in conjunction with a database of document templates. Each template has a number of empty data fields, each data field being associated with a specific type of data present in at least one of the different databases. A document generation module retrieves a document template from the template database and determines which data fields need data. Databases containing the type of data needed by the data fields in the retrieved template are then accessed and suitable data is then retrieved/used and inserted into the retrieved template. Once the template is suitably complete, a document is then output from system and the image of this generated document can then be used with machine learning systems.

### TECHNICAL FIELD

The present invention relates to document generation. More specifically, the present invention relates to systems and methods for automatically generating documents for use in data sets for machine learning purposes.

### BACKGROUND

The explosion in interest in machine learning is a testament to how far machine learning has come since the baby step days of the late 20th century. Machine learning and artificial intelligence is now becoming more ubiquitous as it is used in everything from consumer products to business intelligence systems. One interesting offshoot in these developments is the rise of a market for something necessary for such systems: data.

As is well-known, machine learning systems, especially those that use supervised learning methods, require data and data sets to they can learn and be tested. Suitable data sets, depending on the task to be learned, can be expensive and/or difficult to obtain. For tasks involving business documents, data sets can be difficult to obtain as such documents might contain sensitive information that the owners of the documents would not want to be exposed to the world. Not only that, but given the amount of data that such machine learning systems might need to properly learn a task, a daunting challenge is to obtain and digitize such a large amount of business documents.

From the above, there is therefore a need for systems and methods that can address the above need for voluminous amounts of business documents for use with machine learning systems.

### SUMMARY

The present invention relates to systems and methods for automated generation of documents. In one system, different databases, each having a different type of data, are used in conjunction with a database of document templates. Each template has a number of empty data fields, each data field being associated with a specific type of data present in at least one of the different databases. A document generation module retrieves a document template from the template database and determines which data fields need data. Databases containing the type of data needed by the data fields in the retrieved template are then accessed and suitable data is then retrieved/used and inserted into the retrieved template. Once the template is suitably complete, a document is then output from system and the image of this generated document can then be used with machine learning systems.

In a first aspect, the present invention provides a system for generating a plurality of documents, the system comprising:
a template generation module for generating a plurality of document templates, each of said document templates having a plurality of predefined data fields, each of said predefined data fields being placed at a random location on said document template;
a plurality of data databases, each of said data databases containing predefined data of a specific type, said predefined data being suitable for use in one of said predefined data fields;
a document generator module for assembling a document from one of said plurality of document templates, said document generator module executing a method comprising:
   a) retrieving a document template from said template generation module after said document template has been generated by said template generation module to result in a retrieved template;
   b) determining which of said predefined data fields in said retrieved template requires data;
   c) for at least one of said predefined data fields that require data, determining data to be used as retrieved data, said retrieved data being of a type suitable for use with said predefined data fields that require data;
   d) for each one of said predefined data fields that require data, inserting retrieved data in said predefined data field in said retrieved template;
   e) outputting a completed document resulting from said retrieved template after said retrieved data has been inserted in said predefined data fields that require data.

In another aspect, the present invention provides a system for generating a plurality of documents, the system comprising:
a template database of document templates, said template database containing a plurality of document templates, each of said document templates having a plurality of predefined data fields;
a plurality of data databases, each of said data databases containing predefined data of a specific type, said predefined data being suitable for use in one of said predefined data fields;
a document generator module for assembling a document from one of said plurality of document templates;
wherein said system is configured to:
   a) retrieve one of said plurality of document templates from said template database to result in a retrieved template;
   b) determine which of said predefined data fields in said retrieved template requires data;
   c) for at least one of said predefined data fields that require data, determine data to be used as retrieved data, said retrieved data being of a type suitable for use with said predefined data fields that require data;
   d) for each one of said predefined data fields that require data, insert retrieved data in said predefined data field in said retrieved template;
   e) output a completed document resulting from said retrieved template after said retrieved data has been inserted in said predefined data fields that require data.

In a further aspect, the present invention provides a method for generating documents, the method comprising:
a) receiving a document template, said document template having predefined empty data fields;
b) providing data for use with said with at least one of said predefined empty data fields in said template;
c) inserting said data in at least one of said predefined empty data fields;
d) repeating steps b)-c) until a sufficient amount of predefined empty data fields have been filled;
e) outputting a document comprising said retrieved template and said data;
wherein said documents generated by said method are used in a data set for use by machine learning systems.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a block diagram of a variant of the system in FIG. 1;

FIG. 3 illustrates a sample template for a business letter and which details the various data fields in the template;

FIG. 4 is a diagram of a sample template for a receipt and which details the various data fields in the template; and

FIG. 5 is a diagram of a sample template for an invoice and which details the various data fields in the template.

### DETAILED DESCRIPTION

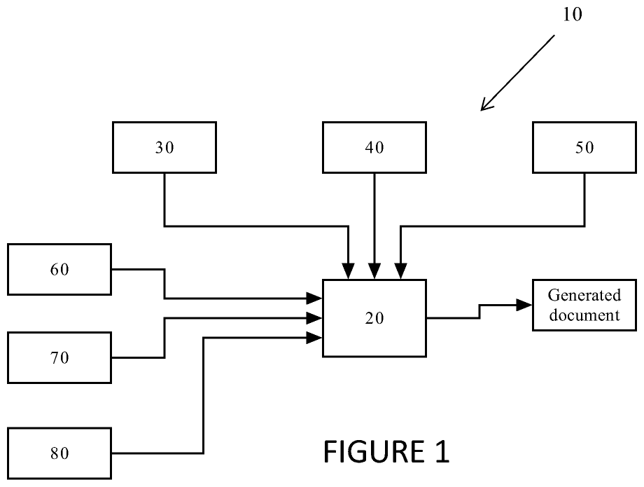

Referring to FIG. 1, a block diagram of a system according to one aspect of the invention is illustrated. As can be seen, the system 10 includes a document generator module 20, a first data database 30, a second data database 40, and a third data database 50. As well, the system includes templates 60, 70, and 80.

Each of the templates 60, 70, 80 is a template for a business document and has specific fields that are designated to receive specific types of data. Each of these data fields is located at specific locations within the template and these locations may differ from template to template. As an example, a data field for an address may be located at a top, middle section of one template but may be located at an upper right corner of another template. Similarly, a field for a business name may be located in a footer location for one template but may be located in an upper left corner of another template.

It should be clear that each of the data databases contain data of a specific data type, with each specific data type being suitable for one or more fields in the templates. As an example, first data database 30 may contain business names, second data database 40 may contain addresses, and third data database may contain product names and/or descriptions. It must be noted that, even though the Figures illustrate multiple databases, a single database (preferably segmented so that different data types populate different segments) may be used.

The generator module receives or retrieves one of the templates and then generates a usable document using data from at least one of the data databases. For use with machine learning systems, an image of the document may be produced, and this image is used with the machine learning systems. As will be explained below, the system can generate multiple user-controlled data sets using user-controlled data (which may be synthetic or real) to populate the various data fields. In addition, the system allows for the injection of randomness into the process such that varied layouts, configurations, appearances, and data content can be generated while retaining the general look and feel of the documents being emulated.

In operation, the system retrieves one of the templates and then populates that template's data fields using data retrieved from one or more of the data databases. A completed document is then produced as a system output. In this process, the data database with a data type for a specific field in a template is queried and one of the database entries is retrieved. The retrieved data is then inserted into an empty data field in the retrieved template. Thus, for a template with a data field for an address, the address database is queried and one of that database's address entries is retrieved. The retrieved data is then inserted into the data field for the address. Of course, templates may have multiple empty data fields that require the same type of data. As an example, an invoice template may have two or more address data fields. For some implementations, the address data fields will require different pieces of data (e.g. one address for an entity issuing the invoice and another address for the entity receiving the invoice). For such implementations, the system would need to query a relevant data database multiple times to retrieve different pieces of data of the same data type. Of course, depending on the projected use for the resulting document, different data fields needing the same data type in a template may not need to have different pieces of data. For such implementations, the system may simply query the relevant data database once to retrieve a single piece of data and that single piece of data can then be used for multiple data fields in the template needing that type of data.

Regarding the templates, these templates may be based on real documents such that the layout of real-world documents is reflected in the templates. The resulting completed documents would thus have the layout of a real-world document while containing synthetic (i.e. generated) or random data in the various data fields.

It should be clear that some fields within a template, while requiring data, may not need data from one of the data databases. As an example, a data field in a template for invoices may have one or more fields that require a number data type (e.g. the template may need an item price or a total for the invoice) or a data type that can be automatically generated (e.g. a date). For such templates, the data may come from one of the data databases or the numbers required may be randomly generated before being inserted into the data field.

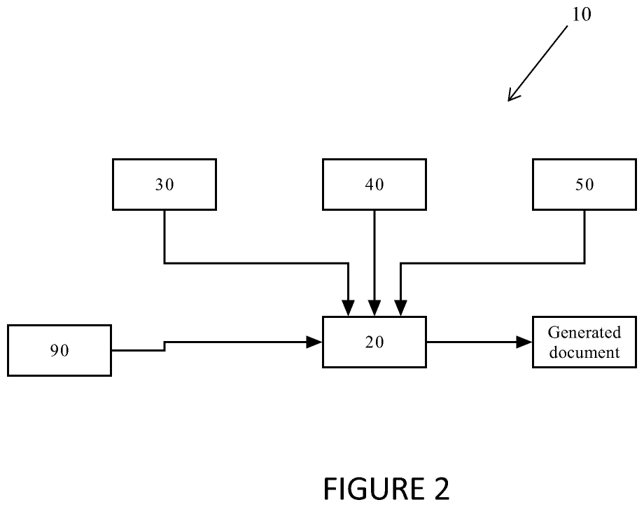

Referring to FIG. 2, a block diagram of a variant of the system in FIG. 1 is illustrated. As can be seen, the system 10 in FIG. 2 is similar to the system in FIG. 1 with the difference being that the system in FIG. 1 uses specific templates as input to the document generator module 20. In FIG. 2, the document generator module 20 receives templates from a template database 90 that contains multiple document templates. In this variant, the template database may randomly select one of its document templates and send this to the document generator module 20. The document generator module 20 can thus populate the necessary data fields in the received template from data from the relevant data databases. Of course, the data from the relevant data databases can also be randomly selected from within the data database—as long as the data selected is of the type required by the empty data field in the template, the data can be used for that empty data field.

Once the document generator module has retrieved enough data to populate a suitable number of data fields within the template being populated, the resulting combination of the template with its fields filled out can be output as a document. The resulting document can then be imaged, and the image can be used with machine learning systems. Of course, it should be clear that not all the empty fields in a template need to be filled for a document to be output from the document generator. Depending on the configuration of the system, once a given percentage of fields are filled or once at least specific data fields are populated, the resulting template can be output as a suitable document to be imaged. As an example, if a template for a business letter has enough data for the business name data field, the address data fields, and the date data fields, the resulting business letter document may be suitable to be output as a completed document ready to be imaged.

As another variant, the system in FIG. 2 can add some more elements of randomness to the document templates. The document templates from the template database 90 may have the location/position of its data fields to be configurable by the template generator module 20. Thus, as an example, for an invoice template, the location of an address data field in that template may be variable within a given area or region of the template. As a result, the output invoice template can have an address field at the top of the template (i.e. within a top region/area of the template) that is one of: flush with a left margin, flush with a right margin, centered, close to the top margin, at a right corner, or at a left corner. The resulting placement of each data field within a given region may thus be user or system configurable.

It should be clear that the configurability of the location/position of data fields in the resulting document template is within predefined parameters. The configurability is not complete as this could result in documents that do not look like the documents they aim to emulate. Thus, as an example, a business name for a business issuing an invoice is expected to be at the top half of the invoice or even in the bottom half of the invoice. Such a business name would not be expected to be located in the middle of the invoice. Accordingly, the business name field would be placed either at the top portion or at the bottom portion of the resulting document template. As another example, the date, reference number (i.e. receipt number), and telephone number of a business issuing a receipt are all expected to be either at the top portion or the bottom portion of the resulting receipt. Thus, the data fields for the date, reference number, and telephone number are to be placed at either the top or the bottom portions of the receipt document template. Of course, the placement or location of these data fields can be randomly determined as long as these data fields are within the expected predefined areas or regions of the document template.

It should also be clear that the presence, absence, and/or duplication of specific data fields in the document template may also be randomly determined. As an example, the date field in a statement document template may be duplicated at both the top and bottom regions of the template. Similarly, such a date field may be present in the bottom region of the template but not in the top region. As well, not all data fields may be present in the document templates. Thus, for example, an invoice document template may not have a telephone data field or an email data field or even a website data field anywhere in the document template. The presence or absence of some of the various data fields may be randomly determined within given, predetermined parameters. As an example, for an invoice template, a date data field and an invoice data field would be necessary and, as such, their presence is not random. However, the presence or absence of an email field or a website field in such an invoice template may be randomly determined.

While the randomness of the placement of the various data fields (within specific regions as noted above) in the document templates may be automated, control of this and other such randomness may be provided to a user. Thus, instead of generating an unconstrained pseudo-random number to determine if a specific data field is to be present in a specific region, a user may provide a range of probabilities that such a data field would appear (or not appear) in that specific region. As an example, the user may configure the system such that there is a 60-75% chance that a date data field appears in the upper portion of an invoice template. The use of such a user defined presence probability parameter may allow for control of whether a specific data field is actually present or not within a specific region or area of the document template or it may allow for control over whether that data field appears anywhere on the template. Of course, this parameter may be specific to multiple data fields or it may be specific to only one data field. Similarly, the user may configure the system such that there is a 25-30% probability that the invoice number is duplicated at the lower or bottom portion of the invoice template. This user defined duplication probability parameter may be used to control the duplication of one or more data fields in the resulting document template. Similarly, the randomness of even the type of document template being generated may be under user control. As an example, if a user requires more samples of account statements with differing configurations and less samples of receipts, the document generator module may be configured to have a 60-70% probability of generating a statement document template, a 10% probability of generating receipt document templates, and a 20% probability of generating an invoice document template.

For ease of use, the system may be provided with a suitable user interface to allow the user to exert some measure of control over the randomness or the probability of placement and/or presence of specific data fields in the document templates. Such a user interface may also be configured to allow the user to control the number and type of document templates and final documents produced by the system.

It should also be clear that while the system uses a document template database in the configuration in FIG. 2, if the system is configured to randomly generate document templates, the system may not need such a document template database. For this configuration, the system would simply need basic templates for the various documents and these basic templates can be randomly populated with specific data fields according to the parameter and probability constraints (which may be user generated) as noted above.

It should be clear from the above that, while the figures only show three data databases, more databases may be used, depending on the configuration of the system. As well, instead of just a single template database, multiple template databases may be used. In another variant, multiple template databases are used, with each template database containing templates for a specific type of document. As an example, a template database for various forms of invoices may be present along with a template database for various configurations and forms of receipts. Of course, if a single template database is used and the templates retrieved are selected in a random manner, a receipt document can be generated in one cycle of the system while, in the next cycle, a business letter document may be generated.

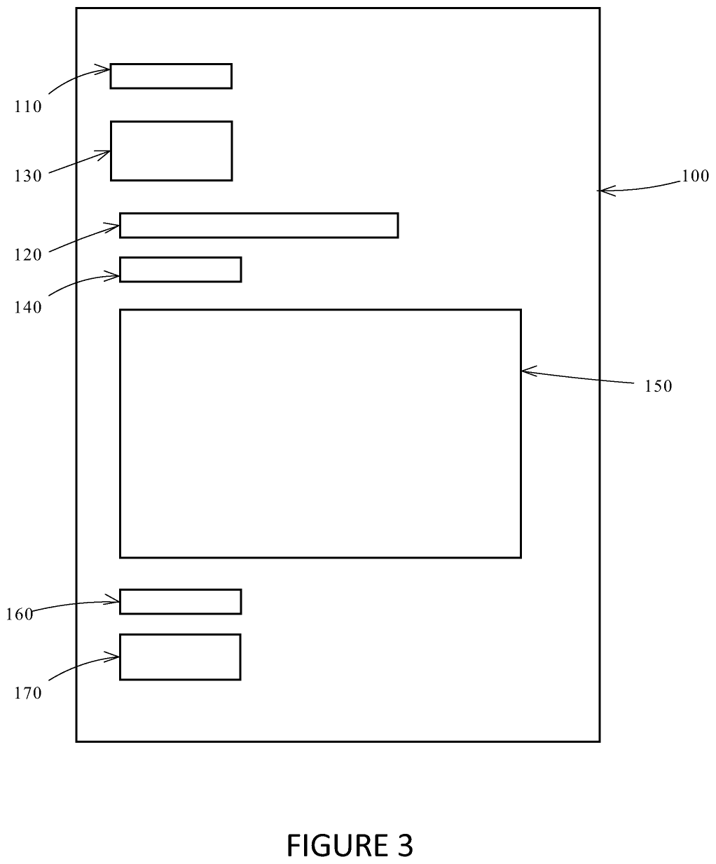

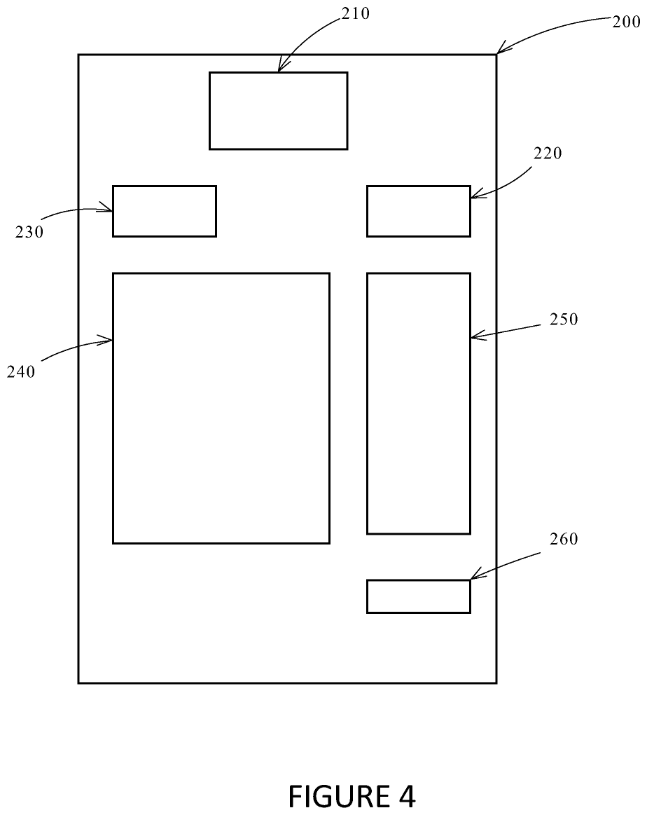

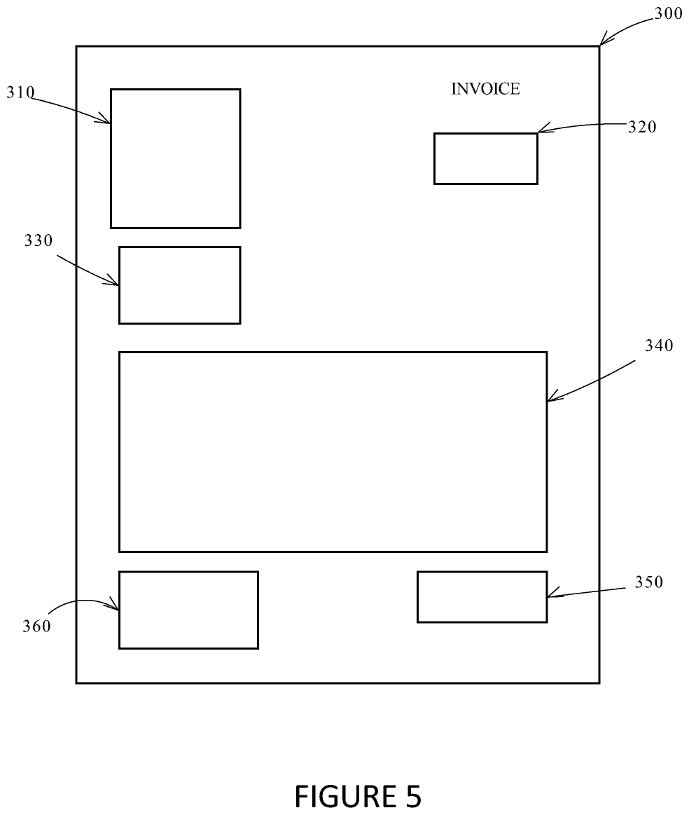

To assist in the explanation of the above, FIGS. 3, 4, and 5 are provided. FIG. 3 illustrates one template structure for a business letter while FIG. 4 illustrates a template structure of a receipt. FIG. 5 illustrates the one template structure for a business invoice. It should be clear that the structures of the varied templates in FIGS. 3, 4, and 5 can be used as a starting point by a variant of the present invention. In this variant, as explained above, the placement of the various data fields can be randomly generated within a set of parameters. As such, the placement of the various data fields noted in the Figures can be varied with the caveat that this placement is approximately within the general area or region noted in the Figures. This allows for different configurations and/or layouts of document templates while retaining an overall similarity in form/content to the base document. Thus, as an example, an invoice template that incorporates randomness can have data fields that are located at different places from corresponding data fields illustrated in FIG. 5 while retaining a similarity in terms of the content and/or function. Such a randomly generated invoice template may have the exact same data fields as that illustrated in FIG. 5 but these data fields would be in different locations. Of course, these locations may be in the same general area or region as the data fields in FIG. 5 to ensure that the resulting document still retains the look, content, and/or feel of an invoice.

As can be seen from FIG. 3, the template 100 has a data field 110 at the top of the document (usually for a date of the letter). Underneath this data field and sandwiched by the other data field 120 is usually an address data field 130. This data field 120 is usually reserved for reference line text data indicating what the letter is in reference to. This data field 120 may sometimes be slightly larger, depending on the context. A salutation data field 140 (i.e. a data field that may include a “Dear Sir” or a “Dear [insert name”) is usually between the data field 120 and the main body 150 of the letter (and this main body 150 may also be a data field). A closing data field 160 and a signature data field 170 are usually at the bottom of the document.

Referring to FIG. 4, the structure of a template for a receipt 200 is illustrated. Such receipts are usually received from consumer establishments such as stores and restaurants. As can be seen, such a receipt 200 may have an address data field 210 at the top of the receipt to indicate the name and location of the business issuing the receipt. A date data field 220 along with a receipt number data field 230 are usually below the address data field 210. It should be noted that while the receipt number data field 230 and the date field 220 are shown as being separate, other receipt template formats have these two data pieces together in a single data field under the address data field. Below the date and receipt number data fields is the body of the receipt, with an itemization data field 240 (which may be broken up into multiple individual item data fields) directly adjacent a price data field 250. Below all these data fields, and usually set apart from other data fields, is a total amount data field 260 for detailing the total amount for the goods and/or services itemized in the body of the receipt.

Referring to FIG. 5, the structure of a template for a business invoice 300 is illustrated. As can be seen, an address data field 310 is near the top of the invoice while a date/invoice number data field 320 is on the other side of the address data field 310. This address data field 310 usually contains the name and address of the issuer of the invoice while a recipient address data field 330 below the address data field 310 would contain the address of the invoice recipient. The body data field 340 would contain the body of the invoice and would have an itemized list of goods and services provided to the recipient. This itemized list can also constitute its own single data field or each entry in the list can be a data field in itself. The total for the invoice is usually set apart in a total data field 350 below and to the right of the body data field. A terms data field 360 is usually present at the bottom and to the left of the body data field 340.

Regarding the output of the system, it is clear from the above that the content of the various data fields may be derived from entries from the various databases or the content may be randomly generated. However, the look of the output may also be randomly generated to ensure the variability of the resulting data set. Thus, the font size, font type, character pitch, and other characteristics of the resulting text in the completed document may be randomly generated or randomly generated within user defined parameters. As an example, an address field in a completed document may be configured to have a different font type, font size, and/or character pitch from the body data field. The system may also be configured to ensure that some data fields are more prominent than others (e.g. an address field may have a larger font size than the content data field) while other data fields are less prominent than others (e.g. a telephone number data field may be configured to use a smaller font size than an address field). The above allows for a variability in the look of the completed documents while retaining the necessary format and/or content and/or layout for the document being emulated.

In addition to the above, not only the look of the content in the various data fields may be randomized but the content itself may be randomly generated. Thus, instead of retrieving a name from a name database and inserting that retrieved name in a name field of a document to be generated, the system may randomly generate a value to insert into that name field. Of course, that randomly generated value may be based on one or more names in the name database so that the randomly generated value at least reflects some of the characteristics of the names in the database. Thus, in one example, instead of retrieving a name value of BILL DOE or JANE ROE or HANNAH LEAFY from a name database (and assuming that these are the only values in the name database), the system may generate a first name that is between four and six characters and a last name that is between three and five characters to thereby reflect the distribution of the name lengths in the database. Or, conversely, the system may randomly jumble the values in the database to result in another value that would be used in the generated document. The system may thus randomly generate values for use in the fields in the generated document with the values being based on parameters derived from the data in one or more of the various databases. It should be clear that, depending on the use that the generated documents are for, the system may be given free rein as to which characters to use in the generation of values for one or more of the fields in the document. Thus, instead of just being limited to letter characters for a name field, the system may generate a name value that includes numbers, letters, punctuation, and other non-traditional characters. By judiciously controlling the parameters for values to be randomly generated for a given field or a given number of fields in a generated document, this and other similar documents can be used to adjust and/or influence what a machine teaming model learns from a training set that includes those documents. In a further variant, the system may generate values for the fields with the values generated simply having some of the characteristics of some or all the values from the database. As an example, for a names database with all the names in the database having between 2 and 15 characters, the system could, instead of retrieving a value from the names database, generate values that would be used in a name field. To mimic the characteristics of the names in the names database, the system could be programmed to randomly generate values having a length of between 2 and 15 characters.

To further reflect real-world documents, the various completed documents generated by the system may have a transformation applied to thereby rotate, translate, or otherwise skew the resulting image. Thus, instead of a centered image of a business document, the resulting image may be an angled image of that document or the resulting image may be a partially obscured image of that document. In extreme cases, the resulting image may be rotated by an angle that can range from a few degrees to 180 degrees. Image artefacts such as folds, creases, dirt, stains, and others that can obfuscate, hide, obscure or otherwise render unclear the text in the completed document can also be introduced into the image of the completed document. In addition, image-based issues may also be introduced to simulate problems with scanning real-world documents. Thus, blurring, insufficient image or color contrast, dark spots, insufficient lighting, and other image-based effects can be applied to the image of the completed document. Other methods may also be used to create completed documents that reflect real-world documents. A style transfer may also be applied to the created documents, with the style being copied or learned from real-world documents. Thus, it should be clear that the transformation applied to the created or completed documents need not be programmatically predetermined. Systems that have learned the style of real-world documents may apply a similar style to the completed document to produce synthetic documents that are more akin to real-world samples.

It should be noted that the documents generated by the system may be used in multiple ways by machine learning systems. These generated documents can be used in training, testing, or validating machine learning systems. In one implementation, the data sets with the generated documents are used in training machine learning systems that learn to identify and/or extract specific data from business documents such as invoices and receipts. One benefit of the system is that each of the completed documents produces labeled data that can be used by machine learning systems. Not only does the system produce labeled data but this labeled data can be controlled by the user and, as such, the user can create customized data sets for specific uses as necessary. Of course, the system can also be used to produce a data set that has as much realistic variability as possible so that the resulting data set represents a distribution that is very close to a real document distribution. Thus, the resulting data set would capture all the intricacies of a real and diverse data set. Such a resulting data set can then be tweaked or adjusted as desired so that it becomes customized to one or more specific use cases.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A system for generating a plurality of documents, the system comprising:
a template generation module for generating a plurality of document templates, each of said document templates having a plurality of predefined data fields, each of said predefined data fields being placed at a random location on said document template;
a plurality of data databases, each of said data databases containing predefined data of a specific type, said predefined data being suitable for use in one of said predefined data fields;
a document generator module for assembling a document from one of said plurality of document templates, said document generator module executing a method comprising:
a) retrieving a document template from said template generation module after said document template has been generated by said template generation module to result in a retrieved template;
b) determining which of said predefined data fields in said retrieved template requires data;
c) for at least one of said predefined data fields that require data, determining data to be used as retrieved data, said retrieved data being of a type suitable for use with said predefined data fields that require data;
d) for each one of said predefined data fields that require data, inserting retrieved data in said predefined data field in said retrieved template;
e) outputting a completed document resulting from said retrieved template after said retrieved data has been inserted in said predefined data fields that require data.

2. The system according to claim 1, wherein said method comprises a step of creating an image of said completed document.

3. The system according to claim 1, wherein documents generated by said system are business-related documents.

4. The system according to claim 3, wherein said documents generated by said system include at least one of: invoices, receipts, purchase orders, statements, tax forms, claim forms, and business letters.

5. The system according to claim 1, wherein, for each one of multiple predefined data fields in a template that requires data of a specific type, said system retrieves different data from a relevant data database for use as retrieved data such that each one of said multiple predefined data fields in said template that requires data of a specific type is populated with different data from other ones of said multiple predefined data fields.

6. The system according to claim 1, wherein, for at least one of multiple predefined data fields in a template that requires data of a specific type, said system retrieves one data point from a relevant data database to be used as retrieved data such that each one of said multiple predefined data fields in said template that requires data of a specific type is populated with said one data point.

7. The system according to claim 1, wherein said plurality of data databases includes at least one of: an address database, a business name database, and a product name database.

8. The system according to claim 1, wherein at least one predefined data field is populated by said document generator module with randomly generated data.

9. The system according to claim 8, wherein said randomly generated data comprises at least one of: dates, totals, prices, names, and numeric data.

10. The system according to claim 1, wherein said at least one user defined parameter comprises a general area on said document template.

11. The system according to claim 10, wherein said at least one user defined parameter comprises a user defined probability that said random location is in said general area.

12. The system according to claim 1, wherein a presence of at least one of said plurality of said predefined data fields on said document template is determined by a user defined presence probability parameter.

13. The system according to claim 1, wherein a presence of a duplication of at least one of said plurality of said predefined data fields on said document template is determined by a user defined duplication probability parameter.

14. The system according to claim 13, wherein, in the event said duplication of at least one of said plurality of said predefined data fields occurs, duplicates of said predefined fields occur in different areas of said document template.

15. The system according to claim 1, wherein said random location is determined according to at least one user defined parameter.

16. The system according to claim 1, wherein said random location is within a predefined region of said document template.

17. The system according to claim 8, wherein said randomly generated data is based on parameters derived from data contained in at least one of said databases.

18. The system according to claim 1, wherein, for step c), data is retrieved from a relevant data database for use as said retrieved data.

19. The system according to claim 1, wherein, for step c), data is generated based on data contained in a relevant data database such that generated data is used as said retrieved data.

20. A system for generating a plurality of documents, the system comprising:
a template database of document templates, said template database containing a plurality of document templates, each of said document templates having a plurality of predefined data fields;
a plurality of data databases, each of said data databases containing predefined data of a specific type, said predefined data being suitable for use in one of said predefined data fields;
a document generator module for assembling a document from one of said plurality of document templates;
wherein said system is configured to:
a) retrieve one of said plurality of document templates from said template database to result in a retrieved template;
b) determine which of said predefined data fields in said retrieved template requires data;
c) for at least one of said predefined data fields that require data, retrieve or use data from a relevant data database to result in retrieved data, said retrieved data being of a type suitable for use with said predefined data fields that require data;
d) for each one of said predefined data fields that require data, insert retrieved data in said predefined data field in said retrieved template;
e) output a completed document resulting from said retrieved template after said retrieved data has been inserted in said predefined data fields that require data.

21. The system according to claim 20, wherein said method comprises a step of creating an image of said completed document.

22. The system according to claim 20, wherein documents generated by said system are business-related documents.

23. The system according to claim 22, wherein said documents generated by said system include at least one of: invoices, receipts, and business letters.

24. The system according to claim 20, wherein, for each one of multiple predefined data fields in a template that require data of a specific type, said system retrieves different data from a relevant data database such that each one of said multiple predefined data fields in said template that require data of a specific type is populated with different data from other ones of said multiple predefined data fields.

25. The system according to claim 20, wherein, for each one of multiple predefined data fields in a template that require data of a specific type, said system retrieves one data point from a relevant data database such that each one of said multiple predefined data fields in said template that require data of a specific type is populated with said one data point.

26. The system according to claim 20, wherein said plurality of data databases includes at least one of: an address database, a business name database, and a product name database.

27. The system according to claim 20, wherein at least one predefined data field is populated by said document generator module with randomly generated data.

28. The system according to claim 27, wherein said randomly generated data comprises at least one of: dates, totals, prices, and numeric data.

29. The system according to claim 27, wherein said randomly generated data is based on parameters derived from data contained in at least one of said databases.

30. A method for generating documents, the method comprising:
a) receiving a document template, said document template having predefined empty data fields;
b) providing data for use with said with at least one of said predefined empty data fields in said template;
c) inserting said data in at least one of said predefined empty data fields;
d) repeating steps b)-c) until a sufficient amount of predefined empty data fields have been filled;
e) outputting a document comprising said retrieved template and said data;
wherein said documents generated by said method are used in a data set for use by machine learning systems.

31. The method according to claim 30, wherein said documents are imaged prior to being used in said data set for use by said machine learning systems.

32. The method according to claim 30, wherein said documents generated by said method are used for training or testing said machine learning systems.

33. The method according to claim 30, wherein said documents generated by said method are used for validating said machine learning systems.

34. The method according to claim 30, wherein said machine learning systems are for identifying specific data types in business documents.

35. The method according to claim 30, wherein said machine learning systems are for extracting specific data types from business documents.

36. The method according to claim 30, further comprising the step of randomly generating data for use in populating at least some of said predefined data fields.

37. The method according to claim 35, wherein randomly generated data for use in populating at least some of said predefined data fields comprises at least one of: dates, totals, prices, and numeric data.

38. The method according to claim 30, further comprising the step of randomly generating a location within a specific region in said document template and placing at least one of said predefined empty data field in said location.

39. The method according to claim 38, wherein said step of randomly generating a location is based on at least one user provided parameter.

40. The method according to claim 30, wherein said data is retrieved from at least one relevant data database, said relevant data database containing data being of a type that is suitable for use with at least one of said empty data fields.

41. The method according to claim 36, wherein randomly generated data is based on parameters derived from data contained in one of said databases.
